(19) United States
(12) Patent Application Publication
(10) Pub. No.: US 2025/0323700 A1
(43) Pub. Date: Oct. 16, 2025

(54) METHOD FOR BEAM TRACKING OF MOBILE NODE IN WIRELESS COMMUNICATION SYSTEM, AND DEVICE USING SAME METHOD

(71) Applicant: LG Electronics Inc., Seoul (KR)

(72) Inventors: Kwansoo KIM, Seoul (KR); Woochan KIM, Seoul (KR)

(21) Appl. No.: 18/866,454

(22) PCT Filed: May 16, 2022
(86) PCT No.: PCT/KR2022/006969

§ 371 Date: Nov. 15, 2024

(51) Int. Cl. H04B 7/06

(52) U.S. Cl. CPC H04B 7/0626; H04B 7/06952

(57) ABSTRACT

Provided are a method for beam tracking performed by a mobile node in a wireless communication system, and a device using the method. The mobile node performs one of SSB/CSI-RS-based beam tracking and beam index-based beam tracking according to a configured mode. In the beam index-based beam tracking, the mobile node and a fixed node exchange beam tables with each other, and the mobile node provides a beam index of a first time point to the fixed node. Thereafter, when a movement event occurs in the mobile node, the mobile node determines a beam index of a second time point in consideration of the beam table of the fixed node and a predicted location of the mobile node due to the movement event, and then provides the determined beam index to the fixed node.

### TECHNICAL FIELD

The present disclosure relates to wireless communications, and more particularly, to a beam tracking method performed by a mobile node in a wireless communication system and a device using the method.

### BACKGROUND ART

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultra-reliable and low latency communication (URLLC) is discussed.

In the next generation of wireless access technologies, terahertz (THz) or millimeter wave (mmWave) may be used. In THz or mmWave operations, the process of beam tracking for mutual beam alignment between transmit and receive is essential, and channel estimation for this purpose incurs overhead and time in terms of radio resources.

For example, conventional channel estimation requires a reference signal, which causes problems such as resource overhead due to the reference signal, reduced channel use efficiency, and reduced throughput.

In addition, in the conventional beam tracking process, as the size of the beam scan range decreases or the number of beams increases, a lot of additional time is required, which may result in beam alignment delay and traffic delay.

6G (6th generation) mobile communications, which are expected to utilize THz, are targeting delays of 0.1 ms and ultra-wideband utilization, and to achieve this, efficient utilization of limited frequency resources and reduction of beam tracking time are essential.

### DISCLOSURE

### Technical Problem

The technical problem to be solved through the present disclosure is to provide a beam tracking method performed by a mobile node in a wireless communication system and a device using the method.

### Technical Solution

In one aspect, provided is a method for beam tracking of a mobile node in a wireless communication system. The mobile node performs one of SSB/CSI-RS-based beam tracking and beam index-based beam tracking depending on the configured mode. In the beam index-based beam tracking, the mobile node exchanges beam tables with a fixed node, and the mobile node provides the fixed node with a beam index at a first time point. Then, when a movement event occurs to the mobile node, the beam index at a second time point is determined by considering the predicted position of the mobile node due to the movement event and the beam table of the fixed node, and then the beam index is provided to the fixed node.

In another aspect, a mobile node, a processing device and a computer readable medium (CRM) implementing the above method are provided.

In a still another aspect, provided is a method performed by a fixed node. The method includes: based on a mobile node being set to a first mode: setting synchronization signal/physical broadcast channel block (SSB) or channel state information-reference signal (CSI-RS) resources to the mobile node for each of a plurality of beams, receiving, from the mobile node, a measurement result of at least one best beam among the plurality of beams, based on the mobile node being set to a second mode: transmitting a first beam table to the mobile node, wherein the first beam table comprising beam information for each of a plurality of beams to be operated by the fixed node, receiving, from the mobile node, a second beam table, wherein the second beam table comprising beam information for each of a plurality of beams to be operated by the mobile node, receiving, from the mobile node, information relating to a first beam index of the second beam table and a first time point, wherein the first beam index is a beam index to be operated by the mobile node at the first time point, receiving, from the mobile node, based on an occurrence of a movement event of the mobile node, information relating to a second beam index of the second beam table and a second time point, wherein the second beam index is a beam index to be operated by the mobile node at the second time point, and wherein based on the first beam index and the second beam index, the fixed node selects a beam index of the first beam table to be used by the fixed node at the second time point.

In a still another aspect, a fixed node implementing the above method is provided.

### Advantageous Effects

By performing beam tracking using beam table information and beam index information, beam tracking time is minimized, and waste of additional channels used for channel estimation and tracking is minimized, thereby increasing traffic capacity and increasing bandwidth efficiency.

### BRIEF DESCRIPTION OF THE DRAWINGS

FIG. 1 shows a wireless communication system.

FIG. 2 is a diagram showing a wireless protocol architecture for a user plane.

FIG. 3 is a diagram showing a wireless protocol architecture for a control plane.

FIG. 4 illustrates a system structure of a next generation radio access network (NG-RAN) to which NR is applied.

FIG. 5 illustrates a functional division between an NG-RAN and a 5GC.

FIG. 6 illustrates physical channels and general signal transmission.

FIG. 7 illustrates an example of a frame structure that may be applied in NR.

FIG. 8 illustrates a slot structure of an NR frame.

FIG. 9 illustrates CORESET.

FIG. 10 is a diagram illustrating a difference between a related art control region and the CORESET in NR.

FIG. 11 illustrates an example of a frame structure for new radio access technology.

FIG. 12 illustrates a structure of a self-contained slot.

FIG. 13 is an abstract diagram of a hybrid beamforming structure from the viewpoint of the TXRU and the physical antenna.

FIG. 14 is a diagram illustrating a beam sweeping operation for a synchronization signal and system information in a downlink (DL) transmission process.

FIG. 15 schematically illustrates a beam sweeping process and frame structure for beam tracking.

FIG. 16 illustrates a process of mutually transmitting beam table-related information between a fixed node and a mobile node during an initial connection process, and beam-related information included in the beam table information.

FIG. 17 illustrates the message transfer process required for fast beam tracking between a fixed node and a mobile node.

FIG. 18 illustrates the operations at the transmitting and receiving nodes during the message transmission and reception process.

FIG. 19 illustrates the process of determining the next beam control time according to the movement of the mobile node.

FIG. 20 illustrates the process of beam prediction in a fixed node.

FIG. 21 illustrates the overall time line of the beam tracking process.

FIG. 22 illustrates a beam tracking method of a mobile node in a wireless communication system.

FIG. 23 illustrates the operation of the mobile node in the first mode.

FIG. 24 illustrates the measurement operation of the mobile node in the first mode.

FIG. 25 illustrates the operation when the mobile node is set to the second mode.

FIG. 26 illustrates a wireless device applicable to the present disclosure.

FIG. 27 shows an example of a structure of a signal processing module in a transmitter.

FIG. 28 shows another example of a structure of a signal processing module in a transmitter.

FIG. 29 illustrates an example of a wireless communication device for implementing the present disclosure.

FIG. 30 shows another example of a wireless device applied to the present disclosure.

FIG. 31 illustrates a communication system 1 applied to the present disclosure.

### MODE FOR INVENTION

In the following disclosure, “/” and “,” should be interpreted as indicating “and/or”. For example, “A/B” may refer to “A and/or B”. “A, B” may refer to “A and/or B”. “A/B/C” may refer to “at least one of A, B, and/or C”. “A, B, C” may refer to “at least one of A, B. and/or C”.

In the following disclosure, “or” should be interpreted as indicating “and/or”. For example, “A or B” may include “only A”. “only B”, and/or “both A and B”. In other words, in the following disclosure, “or” should be interpreted as indicating “additionally or alternatively”.

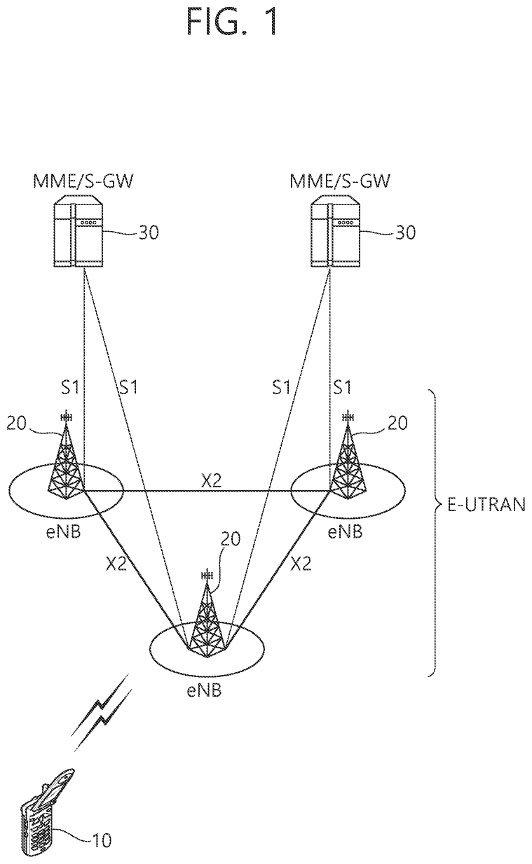

FIG. 1 shows a wireless communication system to which the present disclosure may be applied. The wireless communication system may be referred to as an Evolved-UMTS Terrestrial Radio Access Network (E-UTRAN) or a Long Term Evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, a terminal, a mobile node, etc. The BS 20 is generally a fixed station that communicates with the UE 10 and may be referred to as another terminology, such as an evolved node-B (eNB), a base transceiver system (BTS), an access point, a fixed node, etc.

The BSs 20 are interconnected by means of an X2 interface. The BSs 20 are also connected by means of an SI interface to an evolved packet core (EPC) 30, more specifically, to a mobility management entity (MME) through SI-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

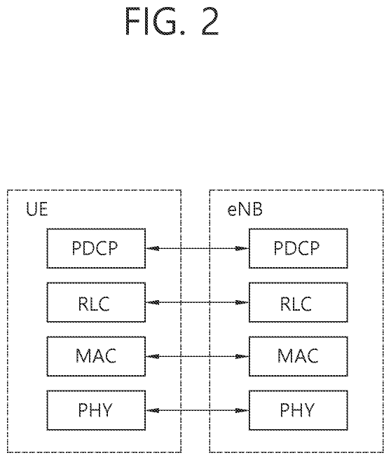

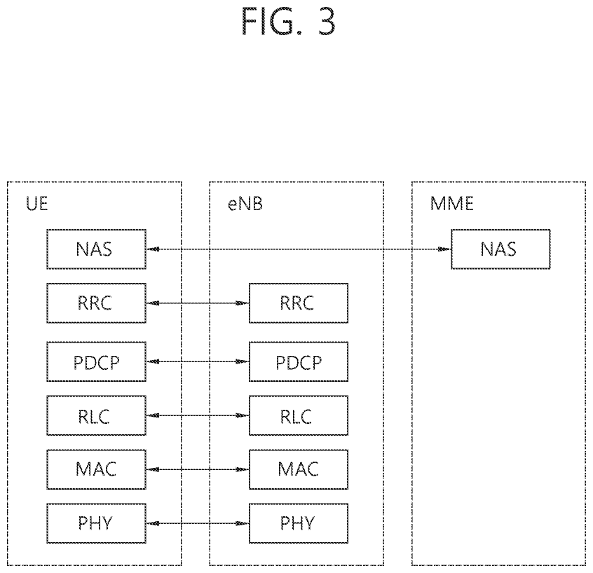

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer (=higher layer) with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (Qos) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

Hereinafter, a new radio access technology (new RAT. NR) will be described.

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultrareliable and low latency communication (URLLC) is discussed. This new technology may be called new radio access technology (new RAT or NR) in the present disclosure for convenience.

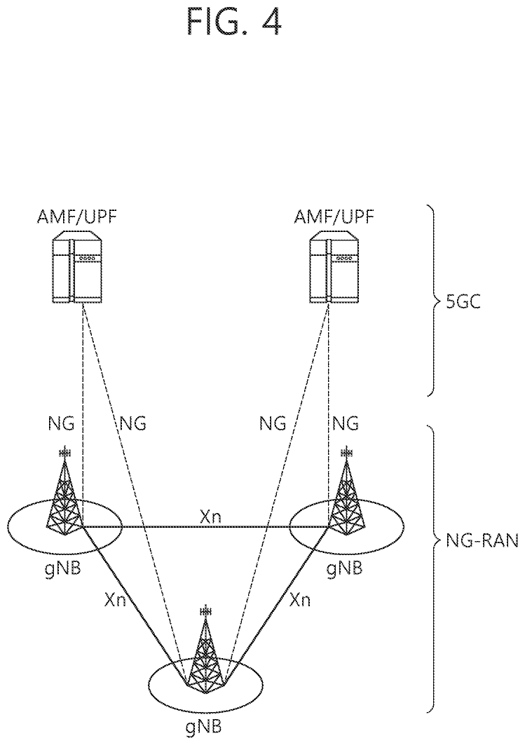

FIG. 4 illustrates a system structure of a next generation radio access network (NG-RAN) to which NR is applied.

Referring to FIG. 4, the NG-RAN may include a gNB and/or an eNB that provides user plane and control plane protocol termination to a terminal. FIG. 4 illustrates the case of including only gNBs. The gNB and the eNB are connected by an Xn interface. The gNB and the eNB are connected to a 5G core network (5GC) via an NG interface. More specifically, the gNB and the eNB are connected to an access and mobility management function (AMF) via an NG-C interface and connected to a user plane function (UPF) via an NG-U interface.

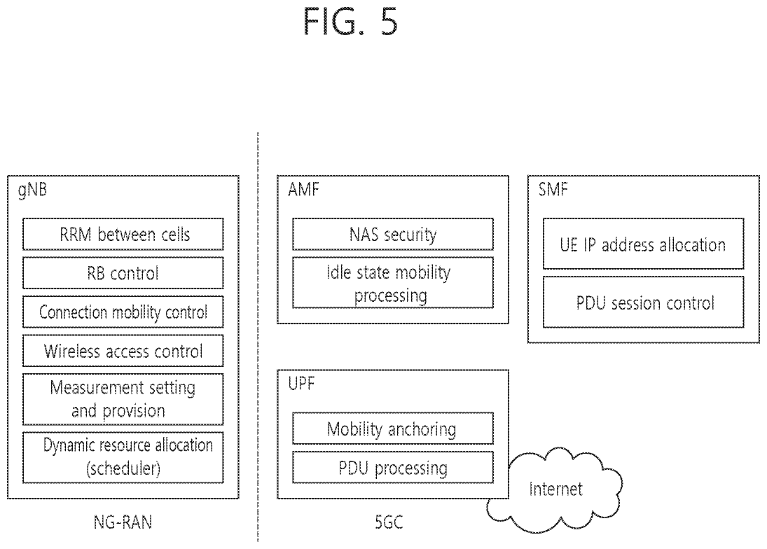

FIG. 5 illustrates a functional division between an NG-RAN and a 5GC.

Referring to FIG. 5, the gNB may provide functions such as an inter-cell radio resource management (Inter Cell RRM), radio bearer management (RB control), connection mobility control, radio admission control, measurement configuration & provision, dynamic resource allocation, and the like. The AMF may provide functions such as NAS security, idle state mobility handling, and so on. The UPF may provide functions such as mobility anchoring, PDU processing, and the like. The SMF may provide functions such as UE IP address assignment, PDU session control, and so on.

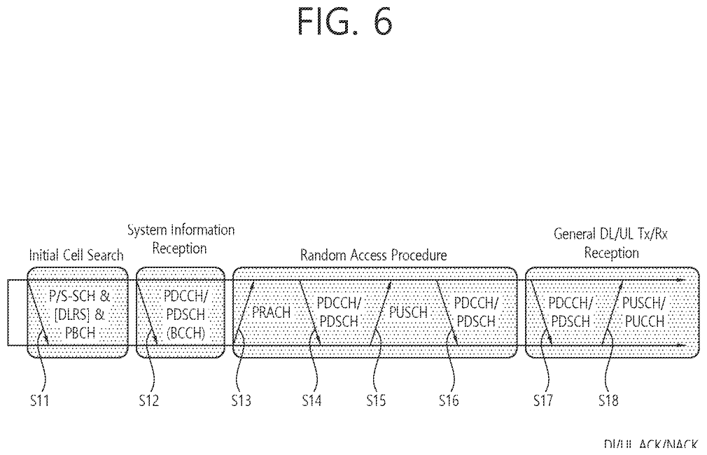

FIG. 6 illustrates physical channels and general signal transmission.

Referring to FIG. 6, in a wireless communication system, a user equipment (UE) (or terminal) receives information from a base station (BS) through a downlink (DL), and the UE transmits information to a BS through an uplink (UL). Information transmitted and received by the base station and the UE includes data and various control information, and various physical channels exist according to types/purposes of information transmitted and received by the BS and the UE.

When power is turned on again in a state where power was turned off or when the UE newly enters a cell, the UE performs an initial cell search operation such as synchronizing with the BS (S11). To this end, the UE is synchronized with the BS upon receiving a primary synchronization channel (PSCH) and a secondary synchronization channel (SSCH) from the BS, and acquires information such as cell identity (cell ID). In addition, the UE may acquire intra-cell broadcast information upon receiving a physical broadcast channel (BPCH) from the BS. In addition, the UE may check a downlink channel state upon receiving a downlink reference signal (DL RS) in an initial cell search step.

After completing the initial cell search, the UE may acquire more detailed system information upon receiving a physical downlink control channel (PDCCH) and a physical downlink control channel (PDSCH) corresponding thereto (S12).

Thereafter, the UE may perform a random access procedure to complete access to the BS (S13 to S16). Specifically, the UE may transmit a preamble through a physical random access channel (PRACH) (S13) and receive a random access response (RAR) for the preamble through a PDCCH and a PDSCH corresponding thereto (S14). Thereafter, the UE may transmit a physical uplink shared channel (PUSCH) using scheduling information in the RAR (S15) and perform a contention resolution procedure such as the PDCCH and the corresponding PDSCH (S16).

After performing the aforementioned procedure, the UE may perform PDCCH/PDSCH reception (S17) and PUSCH/physical uplink control channel (PUCCH) transmission (S18) as a general uplink/downlink signal transmission procedure. Control information transmitted by the UE to the BS is referred to as uplink control information (UCI). The UCI may include a hybrid automatic repeat and request (HARQ) acknowledgement/negative-acknowledgement/negative (ACK NACK), a scheduling request (SR), channel state information (CSI), and the like. The CSI may include a channel quality indicator (CQ1), a precoding matrix indicator (PMI), a rank indication (RI), and the like. The UCI is generally transmitted through the PUCCH, but may be transmitted through PUSCH when control information and data are to be transmitted at the same time. In addition, the UE may aperiodically transmit the UCI through the PUSCH according to a request/instruction of a network.

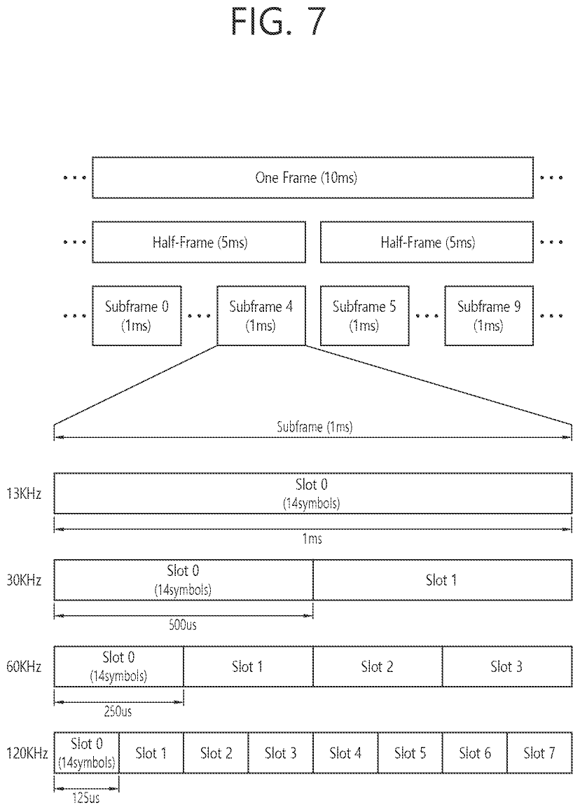

FIG. 7 illustrates a frame structure that may be applied in NR.

Referring to FIG. 7, a frame may consist of 10 milliseconds (ms) and may include 10 subframes consisting of 1 ms.

A subframe may include one or a plurality of slots according to a subcarrier spacing (SCS).

The following table 1 illustrates a subcarrier spacing configuration u.

TABLE 1

| μ | Δf^{μ} · 24.15[kHz] | Cyclic prefix |
|---|---|---|
| 0 | 15 | Normal |
| 1 | 30 | Normal |
| 2 | 60 | Normal |
| | | Extended |
| 3 | 120 | normal |
| 4 | 240 | normal |

Table 1-1 below illustrates the number of symbols per slot, the number of slots per frame, and the number of slots per subframe depending on the SCS, in case of using an extended CP.

TABLE 1-1

| μ | N^{slot}_{symb} | N^{frame,u}ₛₗₒₜ | N^{subframe,u}ₛₗₒₜ |
|---|---|---|---|
| 2 | 12 | 40 | 4 |

The following table 2 illustrates the number of slots in a frame (N^{frame,μ}ₛₗₒₜ), the number of slots in a subframe (N^{subframe,μ}ₛₗₒₜ), the number of symbols in a slot (N^{slot}_{symb}), and the like, according to subcarrier spacing configurations μ.

TABLE 2

| μ | N^{slot}_{symb} | N^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

FIG. 7 illustrates a case of μ=0, 1, 2, 3.

A physical downlink control channel (PDCCH) may include one or more control channel elements (CCE) as shown in Table 3 below.

TABLE 3

| Aggregation level | Number of CCEs |
|---|---|
| 1 | 1 |
| 2 | 2 |
| 4 | 4 |
| 8 | 8 |
| 16 | 16 |

That is, the PDCCH may be transmitted through a resource consisting of 1, 2, 4, 8, or 16 CCEs. Here, the CCE includes six resource element groups (REGs), and one REG includes one resource block in the frequency domain and one orthogonal frequency division multiplexing (OFDM) symbol in the time domain.

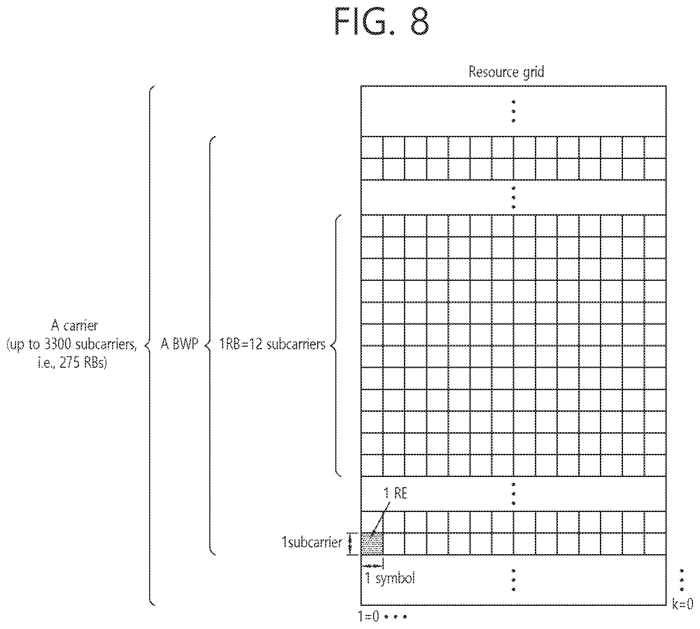

FIG. 8 illustrates a slot structure of an NR frame.

A slot may include a plurality of symbols in a time domain. For example, in case of a normal CP, one slot may include 7 symbols. However, in case of an extended CP, one slot may include 6 symbols. A carrier may include a plurality of subcarriers in a frequency domain. A resource block (RB) may be defined as a plurality of consecutive subcarriers (e.g., 12 subcarriers) in the frequency domain. A bandwidth part (BWP) may be defined as a plurality of consecutive (physical) resource blocks ((P) RBs) in the frequency domain, and the BWP may correspond to one numerology (e.g., SCS, CP length, and so on). The carrier may include up to N (e.g., 5) BWPs. Data communication may be performed via an activated BWP, and only one BWP may be activated for one UE. In a resource grid, each element may be referred to as a resource element (RE), and one complex symbol may be mapped thereto.

Meanwhile, a new unit called a control resource set (CORESET) may be introduced in the NR. The UE may receive a PDCCH in the CORESET.

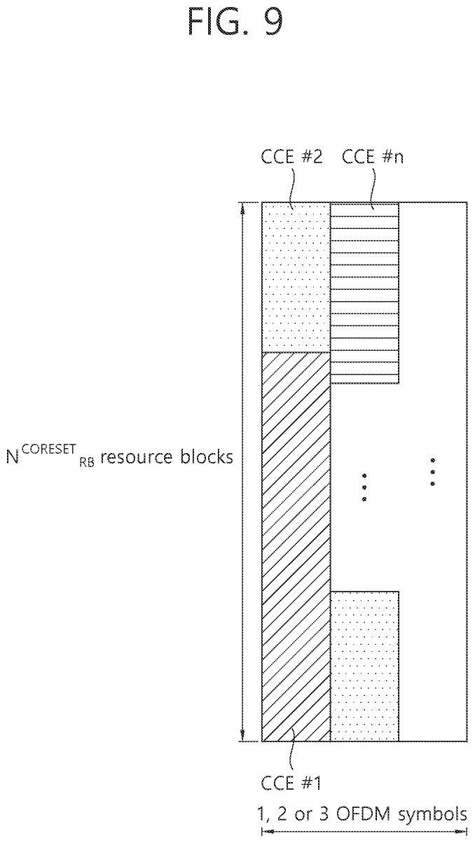

FIG. 9 illustrates CORESET.

Referring to FIG. 9, the CORESET includes N^{CORESET}_{RB} number of resource blocks in the frequency domain, and N^{CORESET}_{symb}∈{1, 2, 3} number of symbols in the time domain. N^{CORESET}_{RB} and N^{CORESET}_{symb} may be provided by a base station via higher layer signaling. As illustrated in FIG. 9, a plurality of CCEs (or REGs) may be included in the CORESET.

The UE may attempt to detect a PDCCH in units of 1, 2, 4, 8, or 16 CCEs in the CORESET. One or a plurality of CCEs in which PDCCH detection may be attempted may be referred to as PDCCH candidates. A plurality of CORESETs may be configured for the UE.

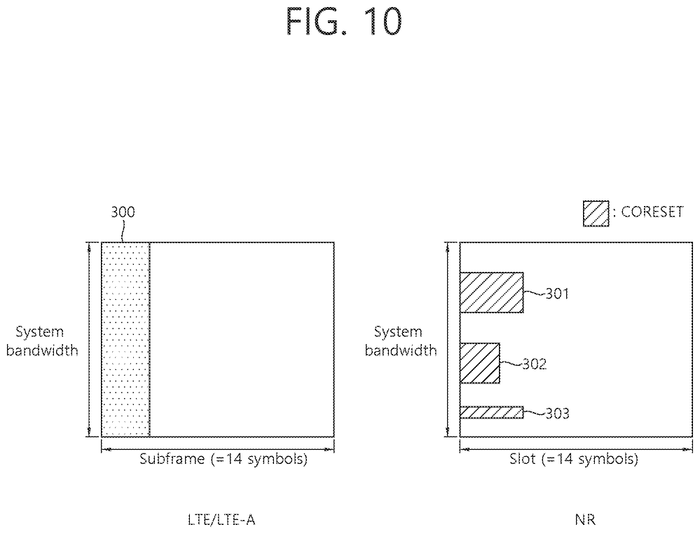

FIG. 10 is a diagram illustrating a difference between a related art control region and the CORESET in NR.

Referring to FIG. 10, a control region 300 in the related art wireless communication system (e.g., LTE/LTE-A) is configured over the entire system band used by a base station (BS). All the UEs, excluding some (e.g., eMTC/NB-IoT UE) supporting only a narrow band, must be able to receive wireless signals of the entire system band of the BS in order to properly receive/decode control information transmitted by the BS.

On the other hand, in NR, CORESET described above was introduced. CORESET's 301, 302, and 303 are radio resources for control information to be received by the UE and may use only a portion, rather than the entirety of the system bandwidth. The BS may allocate the CORESET to each UE and may transmit control information through the allocated CORESET. For example, in FIG. 10, a first CORESET 301 may be allocated to UE 1, a second CORESET 302 may be allocated to UE 2, and a third CORESET 303 may be allocated to UE 3. In the NR, the UE may receive control information from the BS, without necessarily receiving the entire system band.

The CORESET may include a UE-specific CORESET for transmitting UE-specific control information and a common CORESET for transmitting control information common to all UEs.

Meanwhile, NR may require high reliability according to applications. In such a situation, a target block error rate (BLER) for downlink control information (DCI) transmitted through a downlink control channel (e.g., physical downlink control channel (PDCCH)) may remarkably decrease compared to those of conventional technologies. As an example of a method for satisfying requirement that requires high reliability, content included in DCI can be reduced and/or the amount of resources used for DCI transmission can be increased. Here, resources can include at least one of resources in the time domain, resources in the frequency domain, resources in the code domain and resources in the spatial domain.

In NR, the following technologies/features can be applied.

### <Self-Contained Subframe Structure>

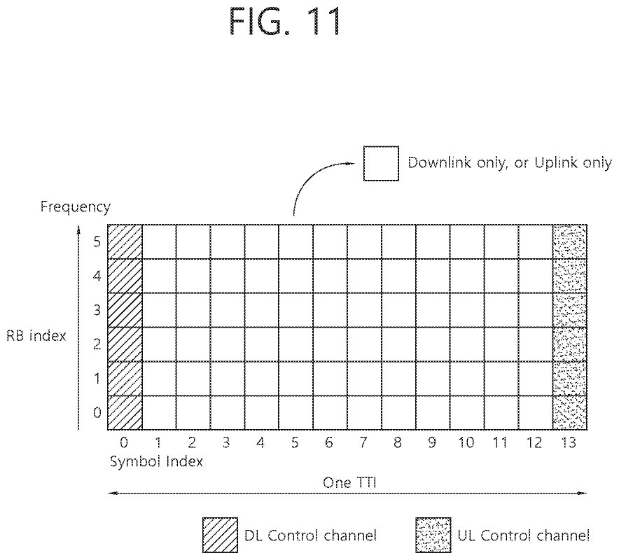

FIG. 11 illustrates an example of a frame structure for new radio access technology.

In NR, a structure in which a control channel and a data channel are time-division-multiplexed within one TTI, as shown in FIG. 11, can be considered as a frame structure in order to minimize latency.

In FIG. 11, a shaded region represents a downlink control region and a black region represents an uplink control region. The remaining region may be used for downlink (DL) data transmission or uplink (UL) data transmission. This structure is characterized in that DL transmission and UL transmission are sequentially performed within one subframe and thus DL data can be transmitted and UL ACK/NACK can be received within the subframe. Consequently, a time required from occurrence of a data transmission error to data retransmission is reduced, thereby minimizing latency in final data transmission.

In this data and control TDMed subframe structure, a time gap for a base station and a UE to switch from a transmission mode to a reception mode or from the reception mode to the transmission mode may be required. To this end, some OFDM symbols at a time when DL switches to UL may be set to a guard period (GP) in the self-contained subframe structure.

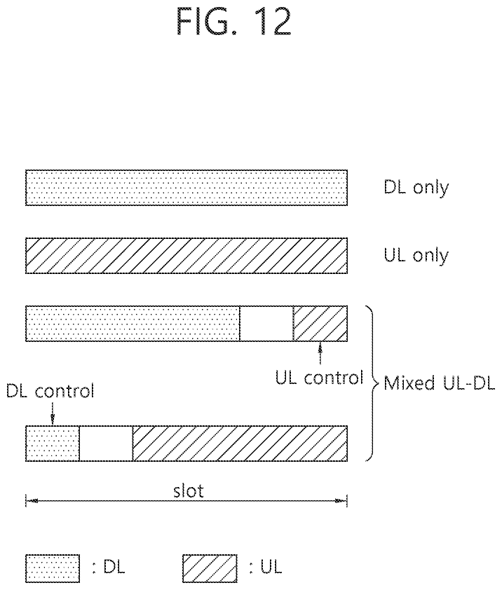

FIG. 12 illustrates a structure of a self-contained slot.

In an NR system, a DL control channel, DL or UL data, a UL control channel, and the like may be contained in one slot. For example, first N symbols (hereinafter, DL control region) in the slot may be used to transmit a DL control channel, and last M symbols (hereinafter, UL control region) in the slot may be used to transmit a UL control channel. N and M are integers greater than or equal to 0. A resource region (hereinafter, a data region) which exists between the DL control region and the UL control region may be used for DL data transmission or UL data transmission. For example, the following configuration may be considered. Respective durations are listed in a temporal order.
1. DL only configuration
2. UL only configuration
3. Mixed UL-DL configuration
   DL region+Guard period (GP)+UL control region
   DL control region+GP+UL region
DL region: (i) DL data region. (ii) DL control region+DL data region
UL region: (i) UL data region, (ii) UL data region+UL control region

A PDCCH may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region. Downlink control information (DCI), for example, DL data scheduling information, UL data scheduling information, and the like, may be transmitted on the PDCCH. Uplink control information (UCI), for example, ACK/NACK information about DL data, channel state information (CSI), and a scheduling request (SR), may be transmitted on the PUCCH. A GP provides a time gap in a process in which a BS and a UE switch from a TX mode to an RX mode or a process in which the BS and the UE switch from the RX mode to the TX mode. Some symbols at the time of switching from DL to UL within a subframe may be configured as the GP.

### <Analog Beamforming #1>

Wavelengths are shortened in millimeter wave (mmW) and thus a large number of antenna elements can be installed in the same area. That is, the wavelength is 1 cm at 30 GHZ and thus a total of 100 antenna elements can be installed in the form of a 2-dimensional array at an interval of 0.5 lambda (wavelength) in a panel of 5×5 cm. Accordingly, it is possible to increase a beamforming (BF) gain using a large number of antenna elements to increase coverage or improve throughput in mmW.

In this case, if a transceiver unit (TXRU) is provided to adjust transmission power and phase per antenna element, independent beamforming per frequency resource can be performed. However, installation of TXRUs for all of about 100 antenna elements decreases effectiveness in terms of cost. Accordingly, a method of mapping a large number of antenna elements to one TXRU and controlling a beam direction using an analog phase shifter is considered. Such analog beamforming can form only one beam direction in all bands and thus cannot provide frequency selective beamforming.

Hybrid beamforming (BF) having a number B of TXRUs which is smaller than Q antenna elements can be considered as an intermediate form of digital BF and analog BF. In this case, the number of directions of beams which can be simultaneously transmitted are limited to B although it depends on a method of connecting the B TXRUs and the Q antenna elements.

### <Analog Beamforming #2>

When a plurality of antennas is used in NR, hybrid beamforming which is a combination of digital beamforming and analog beamforming is emerging. Here, in analog beamforming (or RF beamforming) an RF end performs precoding (or combining) and thus it is possible to achieve the performance similar to digital beamforming while reducing the number of RF chains and the number of D/A (or A/D) converters. For convenience, the hybrid beamforming structure may be represented by N TXRUs and M physical antennas. Then, the digital beamforming for the L data layers to be transmitted at the transmitting end may be represented by an N by L matrix, and the converted N digital signals are converted into analog signals via TXRUs, and analog beamforming represented by an M by N matrix is applied.

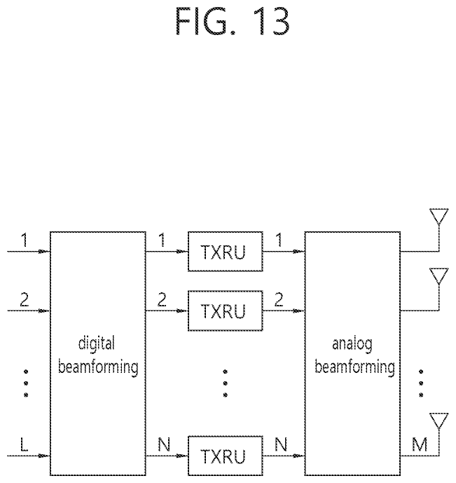

FIG. 13 is an abstract diagram of a hybrid beamforming structure from the viewpoint of the TXRU and the physical antenna.

In FIG. 13, the number of digital beams is L, and the number of analog beams is N. Furthermore, the NR system considers a direction supporting more efficient beamforming for a UE located in a specific area by designing a BS to change analog beamforming in units of symbols. Furthermore, the NR system considers even a method of introducing a plurality of antenna panels to which independent hybrid beamforming may be applied, when specific N TXRUs and M RF antennas are defined as one antenna panel in FIG. 13.

As described above, when a BS uses a plurality of analog beams, analog beams advantageous for signal reception may be different for each UE, and thus, regarding at least a synchronization signal, system information, paging, etc., a beam sweeping operation in which a plurality of analog beams to be applied by a BS in a specific subframe is changed for each symbol so that all Ues may have a reception opportunity is considered.

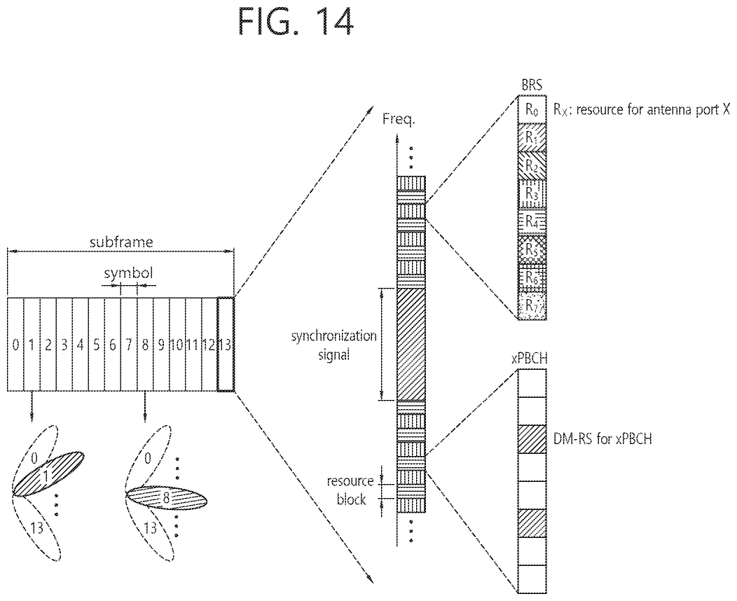

FIG. 14 is a diagram illustrating a beam sweeping operation for a synchronization signal and system information in a downlink (DL) transmission process.

In FIG. 14, a physical resource (or a physical channel) through which system information of an NR system is transmitted in a broadcasting manner is referred to as a physical broadcast channel (xPBCH). Here, analog beams belonging to different antenna panels within one symbol may be simultaneously transmitted, and in order to measure a channel for each analog beam, a method of introducing a beam reference signal (BRS), which is a reference signal (RS) to which a single analog beam (corresponding to a specific antenna panel) is applied and transmitted, as shown in FIG. 14, is under discussion. The BRS may be defined for a plurality of antenna ports, and each antenna port of the BRS may correspond to a single analog beam. In this case, unlike BRS, all analog beams of an analog beam group may be applied to a synchronization signal or xPBCH to transmit the synchronization signal or xPBCH so that any UE may properly receive the synchronization signal or xPBCH.

Now, the present disclosure will be described.

This disclosure is concerned with techniques for achieving fast beam tracking in THz environments and overcoming the reference signal (RS) overhead problem, and proposes a method to perform beam tracking with minimal channel estimation.

Roughly speaking, the first node and the second node exchange their beam tables with each other. After an initial beam align, to ensure continuous and seamless beam tracking, the first node provides the second node with beam index information and control time (which may include inertial sensor information to predict additional position and direction of movement), and the second node uses the received beam index information to predict and control the next beam information. In this way, the beam tracking process between the transmitter and receiver can maximize resource utilization efficiency and minimize tracking time.

First, the problems of prior art are explained.

When operating in THz or mmWave, a tracking process is essential for mutual beam alignment between transmission and reception. However, in conventional technology, additional overhead resources and time are required for channel estimation for this purpose.

Additional reference signals are required for channel estimation, which leads to reduced channel utilization efficiency and throughput due to reference signal overhead.

In addition, during the beam tracking process, as the beam scan range size decreases and the number of beams increases, more additional time is required. Therefore, this can cause delays in beam alignment and traffic delays.

6G mobile communications, which are expected to utilize THz, are targeting a time delay of 0.1 ms and ultra-wideband utilization, and to achieve this, efficient utilization of limited frequency resources and minimum beam tracking time are essential.

This disclosure proposes a technique for transmit/reception beam estimation using beam table information, beam index information, and inertial sensor information (position, velocity, direction information, etc.) to minimize beam tracking time and minimize the waste of additional channels used for channel estimation and tracking, thereby increasing traffic capacity and improving band efficiency.

6G technology is expected to be utilized as a technology that enables ultra-realistic immersive services such as holograms and XR (extended Reality) beyond AR (Augmented Reality)/VR (Virtual Reality)/MR (Mixed Reality). For this purpose, ultra-high performance and ultra-high bandwidth technologies are defined as performance indicators of technology. It is difficult to overcome performance limitations such as delay problems (>1 ms) and bandwidth limitations (<400 Mhz) with existing 5G technology, and is expected to be overcome with technologies such as THz radio technology, full duplex radio (FDR), and beam enhancement in 6G technology. In addition. 6G technology is expected to enable real-time realistic media and real-time control operation of robots and drones.

THz technology suffers from large path attenuation in the atmosphere at short wavelengths, which can be overcome by utilizing small array antennas and generating large gain and directional beam signals to enable broadband signal transmission with THz.

In order to operate the beam, the transmitter and receiver need to match the direction of the beam, which is done by estimating the beam direction and channel using periodic sequence data. This requires the additional transmission of periodic reference signals, which leads to bandwidth inefficiency due to reference signal overheads. In addition, as the number of beams increases and the scanning rage becomes smaller, beam tracking time delays and traffic congestion due to scheduling overload are also likely to occur. 6G technology requires higher speed beam control and operation technology with shorter slot lengths.

Beam operation technology can be configured and operated in a hybrid manner using the advantages of both analogue and digital methods. It is expected that the technology will be applied to each application by simplifying channel configuration and considering the size and cost of the device used.

Inertial sensors (position, altitude, direction, velocity sensors, etc.) are widely used to provide 3D positioning and spatial movement information, which can be used for tracking non-linearly moving devices.

As mentioned above, 6G communication technology should be able to provide ultra-wideband, ultra-low-latency, ultra-connected multi-device technologies using THz, and band-efficient, real-time, and controlled operation of beam control should be basically guaranteed, and the complexity of implementation and simplicity of operation should also be considered. Therefore, new technologies are required to overcome band/channel inefficiencies caused by the use of conventional fixed or periodic sequence information (e.g., reference signals) and to consider cost and power consumption.

The beam prediction technique using only the beam index, table information, and movement information of mobile nodes from inertial sensors is expected to be a step closer to the required performance indicators of 6G technology.

### [Conventional Beam Tracking Techniques and Operating Environments].

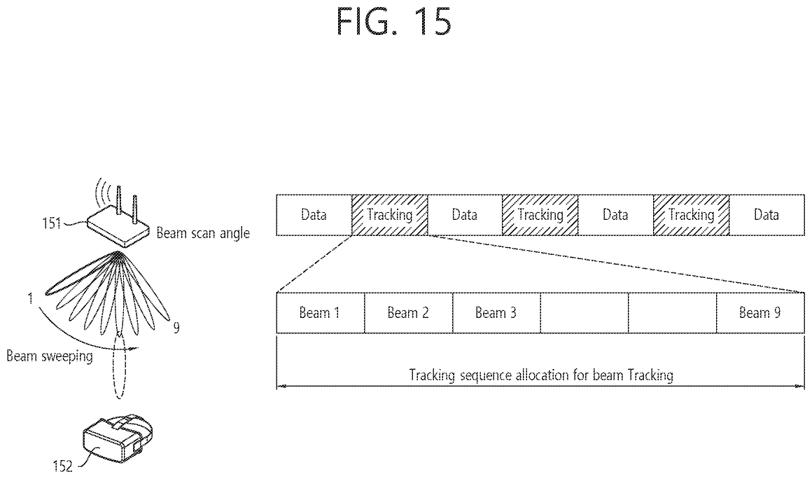

FIG. 15 schematically illustrates the beam sweeping process and frame structure for beam tracking.

Typically, a fixed node (151, e.g., an AP or base station) performs a continuous beam tracking process to secure and maintain beam alignment according to the movement of a mobile node (152, e.g., a UE). For beam tracking, the same process is repeated for some or all beams in the corresponding operational scan angle range. The number of tracking times and time are determined by reflecting the beam operating conditions such as the beam HPBW (Half Power Beam Width) and beam angle resolution of the beam, and the frame structure of the reference signal for channel estimation and tracking.

As shown in FIG. 15, a duration for beam tracking is allocated between data transmission durations. The additional tracking duration result in a reduction of the data channel. Additionally, the problem of having to allocate a larger tracking duration to operate more beams becomes unavoidable.

Due to its frequency characteristics, beam operation is absolutely necessary for THz. and services in the THz environment are expected to include highly realistic and immersive video content (e.g., XR, 360-degree AR/VR). In this situation, fast beam tracking is essential for high-speed data processing of hyper-realistic media and seamless service provision according to UE movement. The present disclosure proposes a fast beam tracking method as follows.

### [Initialization Process for Fast Beam Tracking]

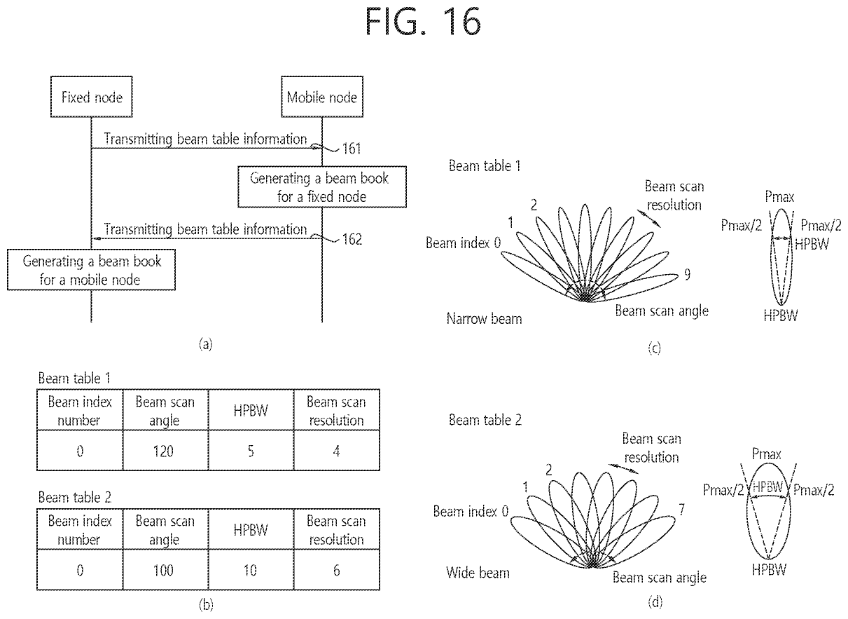

FIG. 16 illustrates a process of mutually transmitting beam table-related information between a fixed node and a mobile node during an initial connection process, and beam-related information included in the beam table information.

Referring to (a) of FIG. 16, the fixed node and the mobile node exchange beam table information with each other by communicating their beam table information to each other (161, 162). The initial exchange of beam table information may occur during the initial setup process after initial beam alignment. This may include exchanging beam index numbers, beam scan angles, half power beam widths (HPBW) of beams, and beam scan resolution (angular difference from neighboring beams) information for individual beams.

In the case of analogue/hybrid beamforming, the beam table can be a table of phase/gain values for each pattern of the beam to be operated after a calibration process prior to operation. In the case of digital beamforming, the one or more available beam information can be stored and operated together with a calibration value before operation. As this is one way of fast beam forming, it is assumed in this document that the available beam conditions are defined in a table or other way before operation.

Referring to (b) of FIG. 16, the beam table may include information such as beam index number, beam scan angle, HPBW, and beam scan resolution for each beam.

(c) of FIG. 16 illustrates beam characteristics according to beam table 1, and (d) of FIG. 16 illustrates beam characteristics according to beam table 2. Depending on the beam scan angle and beam scan resolution, there may be a different number of beams within the same angular range. Depending on the HPBW, the angle covered by each beam may vary.

The beam table information may be exchanged by the fixed node or the mobile node at any time during operation, utilizing the IDLE state, for different beam pattern operation. That is, a particular beam table among the pre-stored beam tables may be changed to a different beam table that fits the service characteristics and the beam table environment of the counter part. The meaning of the pre-stored beam table may mean a calibration beam table for emitting various beam patterns (e.g., Wide and Narrow Beam patterns) before service operation.

The beam index can increase sequentially in a specific direction, but it does not always mean that it has the same pattern of beam shape, and it can have various types of beam patterns depending on the service type.

In general, fixed nodes and mobile nodes will have different conditions such as beam patterns and indices. Therefore, when estimating the next beam index, beam index estimation is performed by considering beam table information (beam scan angle, beam scan resolution) between each other.

Beam scan resolution represents the angle between beams, and the angle, the movement speed/direction of the relative node, and HPBW can be comprehensively determined and used to predict the next beam.

After the initial cell search using PSS, SSS, and SSB, a node makes its own beam estimation based on the next predicted beam index information of the other node without estimating the channel data using reference signals such as CRS (cell-specific reference signal), SRS (sounding reference signal), and CSI-RS (channel state information reference signal), which are used in conventional 4G or 5G. Therefore, a faster beam tracking process can be achieved.

### [Message Transfer for Fast Beam Tracking]

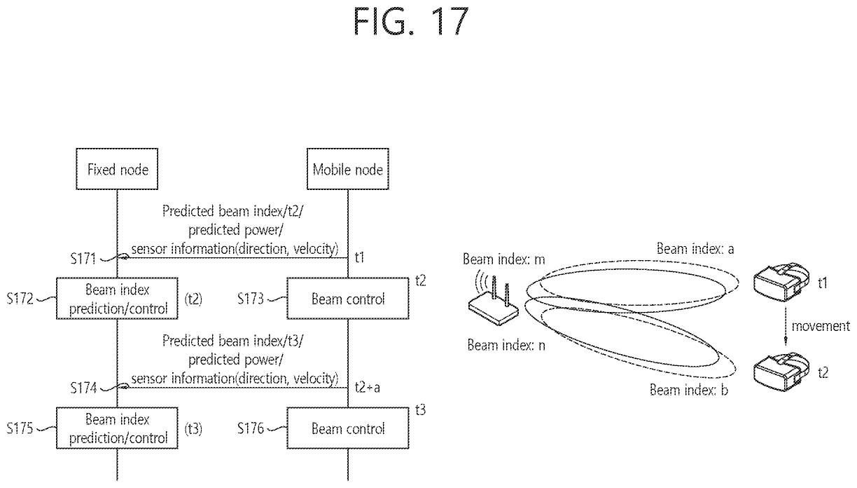

FIG. 17 illustrates the message transfer process required for fast beam tracking between a fixed node and a mobile node.

The mobile node has inertial sensors inside that can detect the direction of movement, speed/altitude, etc.

The mobile node detects a moving event, and based on the inertial sensor information, it predicts the beam control time t2 value, the beam index value at t2, the power value at t2, etc. (let's call these predicted beam information), and provides these to the fixed node at time t1 (S171). In the mobile node, inertial sensor information values can be reported immediately in the form of an interrupt when a change from the previous one is predicted.

Depending on the current beam index and beam table conditions, the mobile node can determine the index value of the next beam to be controlled. Based on this, the control time t2 of the next beam can also be predicted. These can be obtained from the direction and velocity data of the inertial sensors, the angular resolution value of the beam, etc. The power compensation value can also be calculated from the calculated position distance at t2.

The mobile node's predicted beam information may be provided with inertial sensor data and Global Positioning System (GPS) position point information (at 12), or only the predicted beam information may be provided without the inertial sensor data.

Based on the predicted beam information of the mobile node, the fixed node can estimate the moving distance and position information of the mobile node. Based on this, the fixed node can estimate and control the beam index at 12 of the fixed node in consideration of the beam scan angle, beam angle resolution, etc, of the fixed node's own beam table (S172). For example, the fixed node may use a beam of beam index m at t1 and then use a beam of beam index n at t2.

The mobile node can change its beam through beam control at time t2 (S173). For example, the mobile node can use a beam with beam index a at t1 and then use a beam with beam index b at 12.

If a movement event of the mobile node occurs again after time 12, a process similar to the above-described process is repeated (S174, S175, S176). That is, the mobile node detects a movement event at time t2+a, and predicts (predicted beam information) such as the t3 value, which is a beam control time, the beam index value at t3, and the power value at t3 based on the inertial sensor information, and provides this to the fixed node (S174).

The fixed node can estimate the moving distance and position information of the mobile node based on the predicted beam information of the mobile node, and based on this, the fixed node can estimate and control its own beam index at 13 by considering the beam scan angle, beam angle resolution, etc, of its own beam table (S175). The mobile node can change its beam through beam control at time t3 (S176).

A fixed node can store the current beam index value and GPS position information together, depending on the implementation example, and they can also be used as reuse and correction information for subsequent beam estimation.

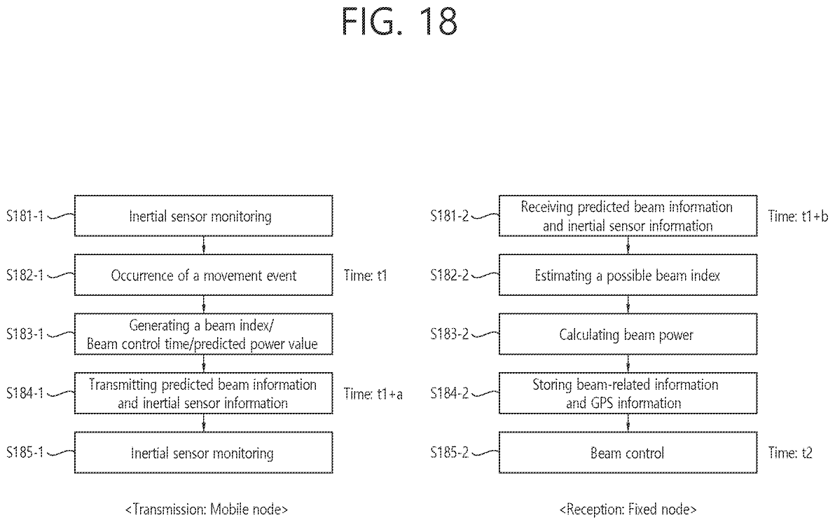

FIG. 18 illustrates the operations at the transmitting and receiving nodes during the message transmission and reception process.

Referring to FIG. 18, if a transmitting node (mobile node) determines that a movement event of the transmitting node has occurred (S182-1) as a result of monitoring (S181-1) of a sensor (e.g., an inertial sensor), it generates a beam index of the next specific point in time, information about the specific point in time, and predicted power information of the specific point in time (S183-1). The transmitting node calculates the position/time of the next beam based on the monitoring results of the inertial sensor, and generates predicted beam information, GPS information, inertial sensor information, etc. The generated information is transmitted to the fixed node (S184-1). After that, inertial sensor monitoring is performed again (S185-1).

A receiving node (fixed node) receives predicted beam information, inertial sensor information, etc, from a transmitting node (S181-2), and uses this to predict/estimate its own possible beam index (S182-2) and calculate beam power (S183-2). Bear-related information and GPS information are stored (S184-2), and beam control is performed (S185-2).

### [Beam Prediction of the Transmitting Node for Fast Beam Tracking (Beam Index Based Time Decision: BBTD)]

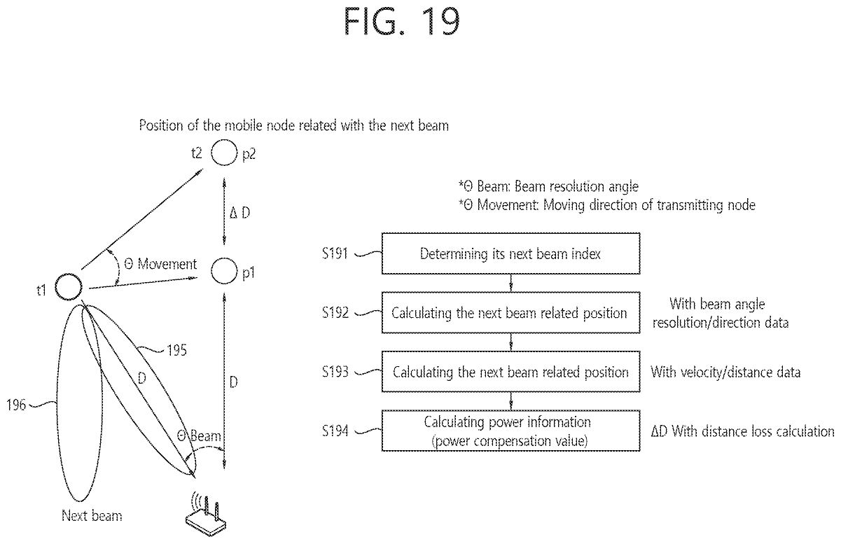

FIG. 19 illustrates a process for determining the next beam control time according to the movement of a mobile node.

Referring to FIG. 19, a mobile node (transmitting node) determines its next beam index (S191) and then calculates the next beam related position (S192). For example, a mobile node may be using beam #1 (195) at t1, and a moving event may occur. The moving speed, direction, distance, etc, of the mobile node can be known through the inertial sensor of the mobile node. A mobile node can use one of a plurality of beams determined according to the beam scan angle and beam scan resolution of its beam table, and can calculate a position where a beam (196) other than the current beam (195) can be used (S193). For example, considering the moving speed and direction of the mobile node, it can be predicted/estimated that the next beam (196) adjacent to the current beam can be used at time t2.

Additionally, the mobile node can calculate power information (power compensation value) at time t2 (S194). For example, if the distance between the mobile node and the fixed node at t1 was D, the distance between the mobile node and the fixed node at 12 could be D+ΔD. In other words, at t2, the mobile node is located at a point ΔD away based on the point (P1) whose distance from the fixed node is D. In this case, since the distance between the mobile node and the fixed node at 12 is greater by ΔD compared to t1, compensation may be required to increase power during signal transmission.

The method of FIG. 19 is a time (12) determination technique using triangulation and time/distance relationships based on the beam scan resolution of the beam table, wherein the transmitting node utilizes its beam table to calculate P2, the position at which the next beam is to be controlled, and predicts the time (12) at this position based on the speed and direction of the transmitting node's movement, distance data, etc.

### [Beam Prediction at the Receiving Node for Fast Beam Tracking (Beam Index Based Time Decision (BBTD)]

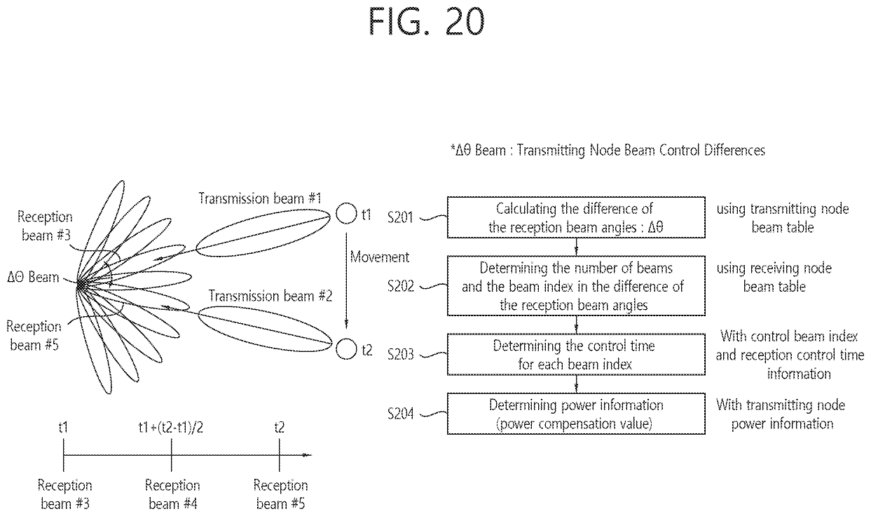

FIG. 20 illustrates the beam prediction process at a receiving node (fixed node).

FIG. 20 illustrates a case where a fixed node and a mobile node have different beam patterns, especially when reception HPBW<transmission HPBW.

A mobile node (transmitting node) can transmit a signal using transmission beam #1 at t1, and transmit a signal using transmission beam #2 at t2 after the occurrence of a movement event.

The fixed node (receiving node) may have a higher beam scan resolution than the mobile node. In this case, the fixed node may receive a signal using reception beam #3 corresponding to transmission beam #1 at t1, receive a signal using reception beam #4 at t1+(t2−t1)/2, and receive a signal using reception beam #5 corresponding to transmission beam #2 at t2.

The fixed node calculates the beam angle required for the next beam control of the fixed node by using the beam index information received from the mobile node, the previous beam index information of the fixed node, and the transmission beam table. Specifically, the fixed node calculates the difference (40) of the reception beam angles (S201) and determines the number of beams included in the difference of the reception beam angles and the beam indices of those beams (S202). The fixed node determines and controls the control time for each beam index of the above beam indices (S203). Additionally, the fixed node can determine power information (power compensation value) (S204).

When there is a difference in beam resolution (beam scan resolution) between a fixed node and a mobile node, the beam control time can be set as shown in the following table by considering the continuity of the reception beam.

TABLE 4

Number of Receive Control Beams N = Maximum Reception
beam Index-Current Reception beam Index.
Receive Control Beam Time (n) = Previous
Beam Control Time + [(Reception beam
Control Time-Previous Beam Control Time) x n]/N:
(N ≠ 0) = Reception beam Control Time: (N = 0) -> No Control

### [Message Transmission Time Line for Fast Beam Tracking]

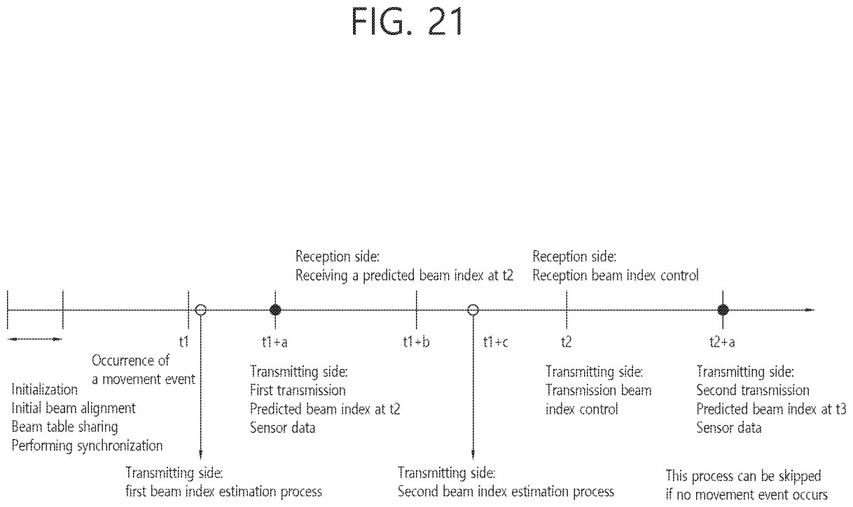

FIG. 21 shows the overall time line of the beam tracking process.

Referring to FIG. 21, the mobile node and the fixed node perform initialization, i.e., perform initial beam alignment, exchange their beam tables with each other, and perform synchronization.

At time t1, after the movement event of the mobile node occurs, the mobile node performs the first beam index estimation process (e.g., beam index estimation at t2, estimation at time t2, power value estimation).

At time t1+a, the mobile node transmits predicted beam information to the fixed node, and at time t1+b, the fixed node can receive the predicted beam information.

At time t1+c, the mobile node can perform the beam index estimation process for time t2+a. This process can be omitted if no movement event occurs.

At time t2, the mobile node/fixed node performs beam control.

At time t2+a, the mobile node can transmit the predicted beam information to the fixed node. This process can be omitted if no movement event occurs.

In summary, 1) for fast beam tracking using the beam index, beam tables are exchanged between the mobile node and the fixed node during the initialization process. 2) After initialization, in the connected state (idle mode), the optimized beam table can be re-exchanged between the mobile node and the fixed node. 3) For the above 2), tables of various beam patterns can be operated and utilized. 4) To perform fast beam tracking using the beam index, beam index information, power information, control time, and inertial sensor information are exchanged.

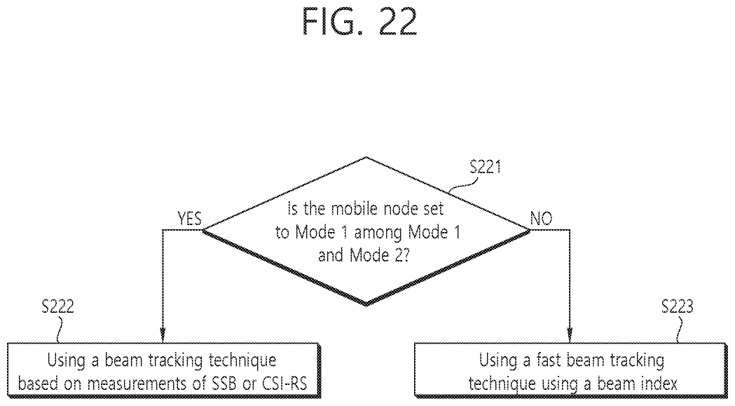

FIG. 22 is an example of a beam tracking method of a mobile node in a wireless communication system.

The mobile node determines whether it is set to the first mode among the first mode and the second mode (S221).

Here, the first mode can be said to be a mode that uses a beam tracking technique based on measurements of SSB (synchronization signal/physical broadcast channel block) or CSI-RS (channel state information-reference signal). The first mode can be said to be a mode that uses the existing beam tracking technique for backward compatibility. On the other hand, the second mode can be said to be a mode that uses the fast beam tracking technique using the aforementioned beam index.

The mobile node can select the optimal beam by using a beam tracking technique based on measurements of SSB or CSI-RS (S222) when the first mode is set.

The mobile node can select an optimal beam by using a fast beam tracking technique using a beam index (S223) when the first mode is not set, that is, when the second mode is set.

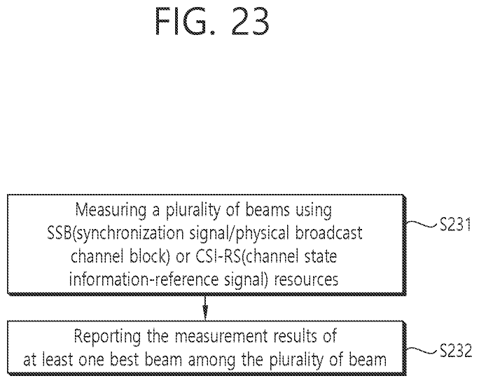

FIG. 23 illustrates the operation of a mobile node in the first mode.

Referring to FIG. 23, the mobile node measures multiple beams using SSB or CSI-RS resources (S231).

The mobile node reports the measurement results of at least one best beam among the plurality of beams to the network (S232).

For example, in the RRC connected state (RRC_CONNECTED), a mobile node such as a UE can measure multiple beams of a cell and derive cell quality by averaging the measurement results (power values). Filtering performed at the UE can occur at two different levels: for example, beam quality can be derived at the physical layer, and then cell quality across multiple beams can be derived at the RRC layer. Cell quality from beam measurements can be derived in the same way for serving cell(s) and non-serving cell(s). The UE can report the measurement results of X best beams, depending on the configuration of the base station.

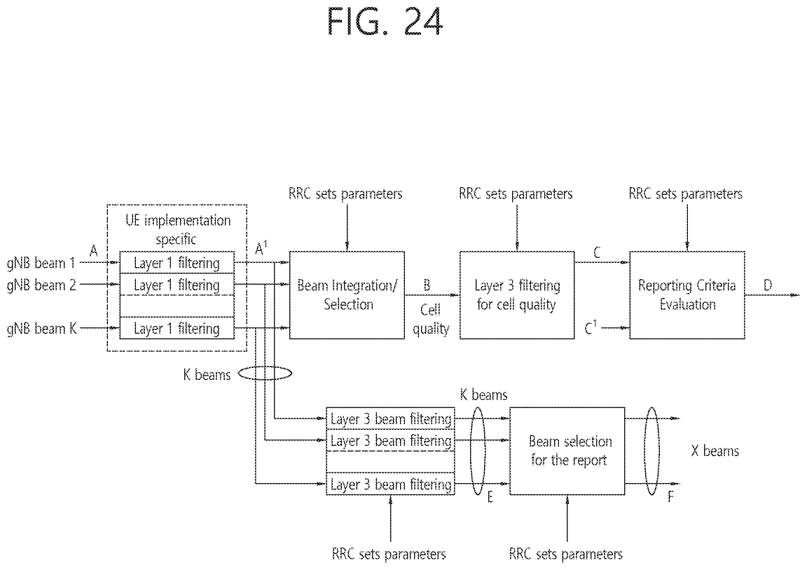

FIG. 24 illustrates the measurement operation of a mobile node in the first mode.

Referring to FIG. 24, K beams can be set by the base station for L3 (layer 3, RRC layer) mobility and correspond to measurements for SSB or CSI-RS resources detected by the UE in L1 (layer 1, physical layer).

A, A¹, B, C, C¹, D, E, and F shown in FIG. 24 may have the following meanings.
A: Measurements within the physical layer.
   Layer 1 Filtering: Internal Layer 1 filtering of the input measured at point A. The exact filtering may vary depending on the implementation. Depending on the implementation (input A and Layer 1 filtering), the way the measurement is actually performed at the physical layer may not be constrained by the standard.
A¹: Means measurements reported from Layer 1 to Layer 3 after Layer 1 filtering (i.e. beam-specific measurements).
   Beam Integration/Selection: Beam-specific measurements can be integrated to derive cell quality. Beam integration/selection operations can be standardized and the configuration of this module can be provided by RRC.
B: Measurements derived from beam-specific measurements reported to Layer 3 after beam integration/selection (e.g., cell quality).
   Layer 3 filtering for cell quality: Filtering performed on measurements provided at point B. The operation of the Layer 3 filter may be standardized and the configuration of the Layer 3 filter can be provided by RRC.
C: Measurement after processing in the Layer 3 filter. This measurement can be used as input for one or more evaluations for the reporting criteria.

Reporting Criteria Evaluation: it can be checked whether actual measurement reporting is required at point D. An evaluation can be based on more than one measurement at a reference point C, allowing comparison of different measurements. This is described by inputs C and C¹. The UE can evaluate the reporting criteria whenever a new measurement result is reported at points C, C¹. The reporting criteria can be standardized and its setting can be provided by RRC.
D: Measurement report information transmitted over the wireless interface.

Layer 3 (L3) Beam Filtering: Filtering performed on measurements provided at point A1 (i.e. beam specific measurements). The operation of the beam filter can be standardized and the configuration of the beam filter can be provided by RRC.
E: Beam selection for beam reporting: X number of measurements can be selected from the measurements provided at point E.
F: Measurement report (transmission) on the wireless interface.

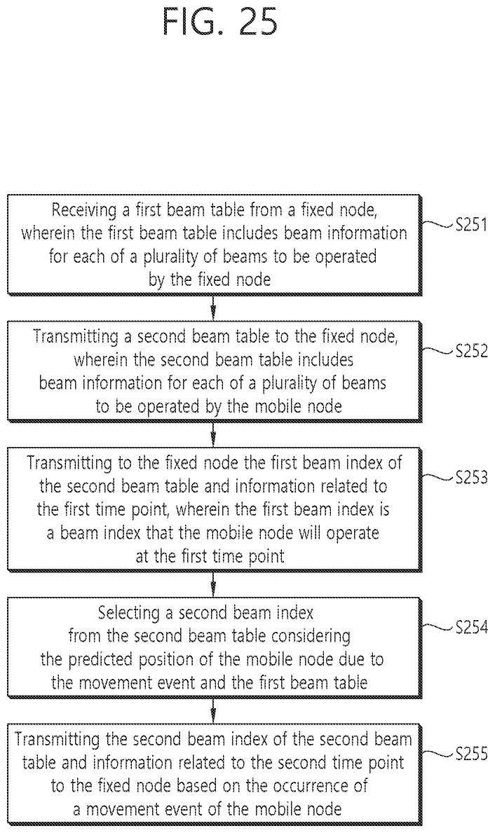

FIG. 25 illustrates the operation when the mobile node is set to the second mode.

Referring to FIG. 25, a mobile node receives a first beam table from a fixed node, wherein the first beam table includes beam information for each of a plurality of beams to be operated by the fixed node (S251).

The mobile node transmits a second beam table to the fixed node, wherein the second beam table includes beam information for each of a plurality of beams to be operated by the mobile node (S252).

The first beam table and the second beam table may include information such as a beam index for each beam, a beam scan angle, a half power beam width (HPBW) of the beam, and a beam scan resolution (angle difference from an adjacent beam), as described in FIG. 16. The mobile node transmits to the fixed node the first beam index of the second beam table and information related to the first time point, wherein the first beam index is a beam index that the mobile node will operate at the first time point (S253).

The mobile node selects a second beam index from the second beam table based on the occurrence of a movement event of the mobile node, taking into consideration the predicted position of the mobile node due to the movement event and the first beam table (S254).

The mobile node transmits the second beam index of the second beam table and information related to the second time point to the fixed node based on the occurrence of a movement event of the mobile node (S255).

When transmitting the first beam index, at least one of the first predicted power information and inertial sensor information to be used at the first time point may be transmitted together.

When transmitting the second beam index, at least one of the second predicted power information and inertial sensor information to be used at the second time point may be transmitted together.

The first beam index, the first predicted power information, the second beam index, and the second predicted power information may be used by the fixed node to estimate a beam index of the first beam table to be used by the fixed node at the second time point.

When transmitting the first beam index, the position information and inertial sensor information of the mobile node related to the first time point can be transmitted together.

When transmitting the second beam index, the position information and inertial sensor information of the mobile node related to the second time point can be transmitted together.

The above position information and the inertial sensor information can be used by the fixed node to estimate the predicted location of the mobile node.

The above second beam table may be specific to the mobile node.

The method of FIG. 25 further includes a step of the mobile node transmitting a third beam table to the fixed node, wherein the third beam table may be a beam table that updates the second beam table.

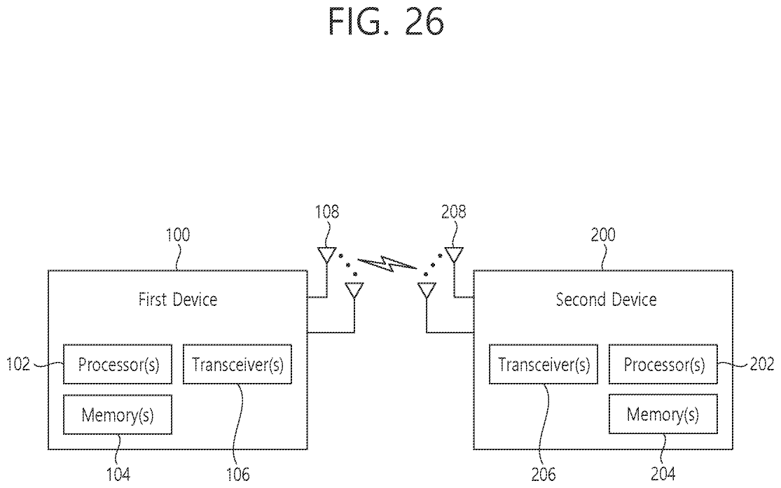

FIG. 26 illustrates a wireless device applicable to the present disclosure.

Referring to FIG. 26, a first wireless device 100 and a second wireless device 200 may transmit radio signals through a variety of RATs (e.g., LTE and NR).

The first wireless device 100 may include one or more processors 102 and one or more memories 104 and additionally further include one or more transceivers 106 and/or one or more antennas 108. The processors 102 may control the memory 104 and/or the transceivers 106 and may be configured to implement the descriptions, functions, procedures, proposals, methods, and/or operational flowcharts disclosed in this document. For example, the processors 102 may process information within the memory 104 to generate first information/signals and then transmit radio signals including the first information/signals through the transceivers 106. In addition, the processor 102 may receive radio signals including second information/signals through the transceiver 106 and then store information obtained by processing the second information/signals in the memory 104. The memory 104 may be connected to the processory 102 and may store a variety of information related to operations of the processor 102. For example, the memory 104 may store software code including commands for performing a part or the entirety of processes controlled by the processor 102 or for performing the descriptions, functions, procedures, proposals, methods, and/or operational flowcharts disclosed in this document. Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. The transceiver 106 may include a transmitter and/or a receiver. The transceiver 106 may be interchangeably used with a radio frequency (RF) unit. In the present specification, the wireless device may represent a communication modem/circuit/chip.

The first wireless device 100 may be the mobile node described above. The mobile node measures a plurality of beams using synchronization signal/physical broadcast channel block (SSB) or channel state information-reference signal (CSI-RS) resources, reports a measurement result of at least one best beam among the plurality of beams, based on the mobile node being set to a first mode. The mobile node receives a first beam table from a fixed node, based on the mobile node being set to a second mode, wherein the first beam table comprising beam information for each of a plurality of beams to be operated by the fixed node. The mobile node transmits a second beam table to the fixed node, wherein the second beam table comprising beam information for each of a plurality of beams to be operated by the mobile node. The mobile node transmits to the fixed node information relating to a first beam index of the second beam table and a first time point, wherein the first beam index is a beam index to be operated by the mobile node at the first time point. The mobile node transmits to the fixed node, based on an occurrence of a movement event of the mobile node, information relating to a second beam index of the second beam table and a second time point, wherein the second beam index is a beam index to be operated by the mobile node at the second time point, and wherein the second beam index is selected from the second beam table, taking into account a predicted position of the mobile node due to the movement event and the first beam table.

The second wireless device 200 may include one or more processors 202 and one or more memories 204 and additionally further include one or more transceivers 206 and/or one or more antennas 208. The processor 202 may control the memory 204 and/or the transceiver 206 and may be configured to implement the descriptions, functions, procedures, proposals, methods, and/or operational flowcharts disclosed in this document. For example, the processor 202 may process information within the memory 204 to generate third information/signals and then transmit radio signals including the third information/signals through the transceiver 206. In addition, the processor 202 may receive radio signals including fourth information/signals through the transceiver 106 and then store information obtained by processing the fourth information/signals in the memory 204. The memory 204 may be connected to the processor 202 and may store a variety of information related to operations of the processor 202. For example, the memory 204 may store software code including commands for performing a part or the entirety of processes controlled by the processor 202 or for performing the descriptions, functions, procedures, proposals, methods, and/or operational flowcharts disclosed in this document. Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. The transceiver 206 may include a transmitter and/or a receiver. The transceiver 206 may be interchangeably used with an RF unit. In the present specification, the wireless device may represent a communication modem/circuit/chip.

The second wireless device 200 may be the fixed node described above. The fixed node sets synchronization signal/physical broadcast channel block (SSB) or channel state information-reference signal (CSI-RS) resources to the mobile node for each of a plurality of beams, receives, from the mobile node, a measurement result of at least one best beam among the plurality of beams, based on the mobile node being set to a first mode. The fixed node transmits a first beam table to the mobile node based on the mobile node being set to a second mode, wherein the first beam table comprising beam information for each of a plurality of beams to be operated by the fixed node. The fixed node receives, from the mobile node, a second beam table, wherein the second beam table comprising beam information for each of a plurality of beams to be operated by the mobile node. The fixed node receives, from the mobile node, information relating to a first beam index of the second beam table and a first time point, wherein the first beam index is a beam index to be operated by the mobile node at the first time point. The fixed node receives, from the mobile node, based on an occurrence of a movement event of the mobile node, information relating to a second beam index of the second beam table and a second time point, wherein the second beam index is a beam index to be operated by the mobile node at the second time point, and wherein based on the first beam index and the second beam index, the fixed node selects a beam index of the first beam table to be used by the fixed node at the second time point.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. In addition, the one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. In addition, the one or more processors 102 and 202 may perform control so that the one or more transceivers 106 and 206 may receive user data, control information, or radio signals from one or more other devices. In addition, the one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc, from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

In FIG. 26, the case where the processor and memory are configured separately is exemplified, but this is not a limitation. That is, the processor and memory may be combined into one device (i.e., one chipset).

Hereinafter, an example of a structure of a signal processing module of a transmitter to which the present disclosure is applied will be described.

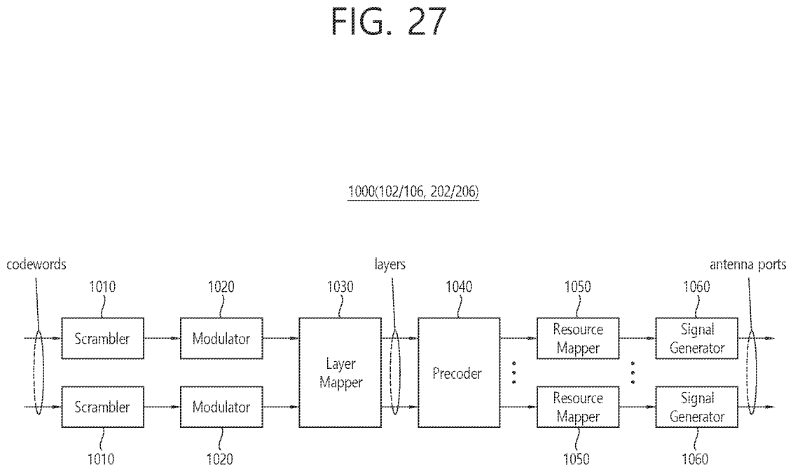

FIG. 27 is an example of a structure of a signal processing module of a transmitter.

Referring to FIG. 27, a signal processing circuit 1000 may include a scrambler 1010, a modulator 1020, a layer mapper 1030, a precoder 1040, a resource mapper 1050, and a signal generator 1060. Although not limited thereto, the operations/functions of FIG. 27 may be performed in the processors 102 and 202 and/or the transceivers 106 and 206 of FIG. 26. The hardware elements of FIG. 27 may be implemented in the processors 102 and 202 and/or the transceivers 106 and 206 of FIG. 26. For example, blocks 1010 to 1060 may be implemented in the processors 102 and 202 of FIG. 26. Further, blocks 1010 to 1050 may be implemented in the processors 102 and 202 of FIG. 26, and block 1060 may be implemented in the transceivers 106 and 206 of FIG. 26.

A codeword may be converted into a wireless signal through the signal processing circuit 1000 of FIG. 27. Here, the codeword is an encoded bit sequence of an information block. The information block may include a transport block (e.g., a UL-SCH transport block or a DL-SCH transport block). A wireless signal may be transmitted through various physical channels (e.g., PUSCH or PDSCH).

Specifically, the codeword may be converted into a bit sequence scrambled by the scrambler 1010. A scrambled sequence used for scramble may be generated based on an initialization value, and the initialization value may include ID information of a wireless device. The scrambled bit sequence may be modulated into a modulation symbol sequence by the modulator 1020. A modulation scheme may include pi/2-binary phase shift keying (pi/2-BPSK), m-phase shift keying (m-PSK), m-quadrature amplitude modulation (m-QAM), and the like. A complex modulation symbol sequence may be mapped to one or more transport layers by the layer mapper 1030. Modulation symbols of each transport layer may be mapped to corresponding antenna port(s) by the precoder 1040 (precoding). An output z of the precoder 1040 may be obtained by multiplying an output y of the layer mapper 1030 by an N*M precoding matrix W. Here, N is the number of antenna ports, and M is the number of transport layers. Here, the precoder 1040 may perform precoding after performing transform precoding (e.g., DFT transform) on complex modulation symbols. Also, the precoder 1040 may perform precoding without performing transform precoding.

The resource mapper 1050 may map modulation symbols of each antenna port to a time-frequency resource. A time-frequency resource may include a plurality of symbols (e.g., CP-OFDMA symbols or DFT-s-OFDMA symbols) in a time domain and may include a plurality of subcarriers in a frequency domain. The signal generator 1060 may generate a wireless signal from the mapped modulation symbols, and the generated wireless signal may be transmitted to another device through each antenna. To this end, the signal generator 1060 may include an inverse fast Fourier transform (IFFT) module, a cyclic prefix (CP) inserter, a digital-to-analog converter (DAC), a frequency uplink converter, and the like.

A Signal processing process for a received signal in a wireless device may be configured as the reverse of the signal processing process 1010 to 1060 of FIG. 27. For example, a wireless device (e.g., 100 and 200 in FIG. 26) may receive a wireless signal from the outside through an antenna port/transceiver. The received wireless signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be reconstructed into a codeword through a resource de-mapper process, a postcoding process, a demodulation process, and a de-scramble process. The codeword may be restored to an original information block through decoding. Accordingly, a signal processing circuit (not shown) for a received signal may include a signal restorer, a resource demapper, a postcoder, a demodulator, a descrambler, and a decoder.

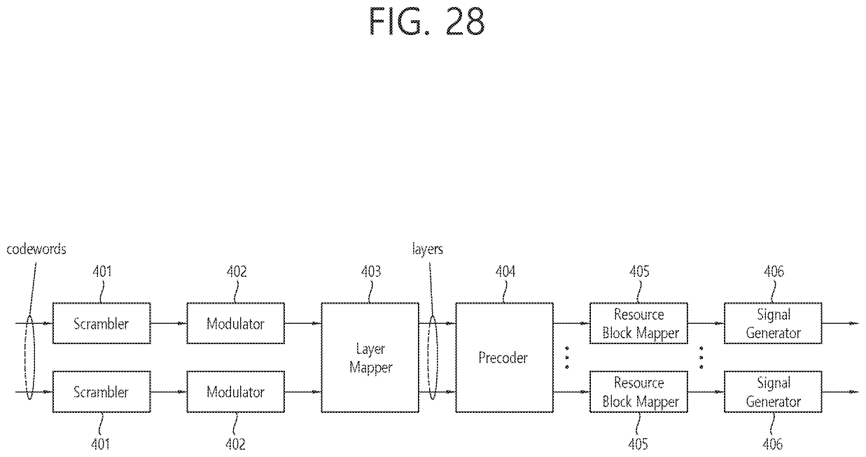

FIG. 28 shows another example of a structure of a signal processing module in a transmission device. Here, signal processing may be performed by a processor of a UE/BS such as the processors 102 and 202 of FIG. 26.

Referring to FIG. 28, a transmission device (e.g., 102, 202, 106, or 206) in a UE or a BS may include a scrambler 401, a modulator 402, a layer mapper 403, a precoder 404, a resource block mapper 405, and a signal generator 406.

The transmitting device can scramble coded bits in a codeword by the corresponding scrambler 401 and then transmit the scrambled coded bits through a physical channel.

Scrambled bits are modulated into complex-valued modulation symbols by the corresponding modulator 402. The modulator can modulate the scrambled bits according to a predetermined modulation scheme to arrange complex-valued modulation symbols representing positions on a signal constellation. The modulation scheme is not limited and pi/2-BPSK (pi/2-Binary Phase Shift Keying), m-PSK (m-Phase Shift Keying) or m-QAM (m-Quadrature Amplitude Modulation) may be used to modulate the coded data.

The complex-valued modulation symbols can be mapped to one or more transport layers by the layer mapper 403.

Complex-valued modulation symbols on each layer can be precoded by the precoder 404 for transmission on an antenna port. Here, the precoder may perform transform precoding on the complex-valued modulation symbols and then perform precoding. Alternatively, the precoder may perform precoding without performing transform precoding. The precoder 404 can process the complex-valued modulation symbols according to MIMO using multiple transmission antennas to output antenna-specific symbols and distribute the antenna-specific symbols to the corresponding resource block mapper 405. An output z of the precoder 404 can be obtained by multiplying an output y of the layer mapper 403 by an Nx M precoding matrix W. Here, N is the number of antenna ports and M is the number of layers.

Each resource block mapper 405 maps complex-valued modulation symbols with respect to each antenna port to appropriate resource elements in a virtual resource block allocated for transmission.

The resource block mapper 405 can allocate complex-valued modulation symbols to appropriate subcarriers and multiplex the complex-valued modulation symbols according to a user.

Signal generator 406 can modulate complex-valued modulation symbols according to a specific modulation scheme, for example, OFDM, to generate a complex-valued time domain OFDM symbol signal. The signal generator 406 can perform IFFT (Inverse Fast Fourier Transform) on antenna-specific symbols, and a CP (cyclic Prefix) can be inserted into time domain symbols on which IFFT has been performed. OFDM symbols are subjected to digital-analog conversion and frequency up-conversion and then transmitted to the receiving device through each transmission antenna. The signal generator 406 may include an IFFT module, a CP inserting unit, a digital-to-analog converter (DAC) and a frequency upconverter.

The signal processing procedure of the receiving device may be reverse to the signal processing procedure of the transmitting device. Specifically, the processor of the transmitting device decodes and demodulates RF signals received through antenna ports of the transceiver. The receiving device may include a plurality of reception antennas, and signals received through the reception antennas are restored to baseband signals, and then multiplexed and demodulated according to MIMO to be restored to a data string intended to be transmitted by the transmitting device. The receiving device may include a signal restoration unit that restores received signals to baseband signals, a multiplexer for combining and multiplexing received signals, and a channel demodulator for demodulating multiplexed signal strings into corresponding codewords. The signal restoration unit, the multiplexer and the channel demodulator may be configured as an integrated module or independent modules for executing functions thereof. More specifically, the signal restoration unit may include an analog-to-digital converter (ADC) for converting an analog signal into a digital signal, a CP removal unit that removes a CP from the digital signal, an FET module for applying FFT (fast Fourier transform) to the signal from which the CP has been removed to output frequency domain symbols, and a resource element demapper/equalizer for restoring the frequency domain symbols to antenna-specific symbols. The antenna-specific symbols are restored to transport layers by the multiplexer and the transport layers are restored by the channel demodulator to codewords intended to be transmitted by the transmitting device.

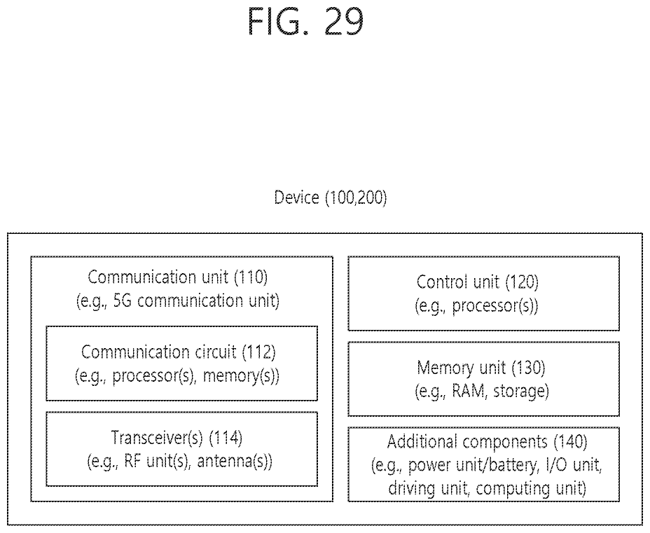

FIG. 29 shows another example of a wireless device applied to the present disclosure. The wireless device may be implemented in various forms according to use-examples/services.

Referring to FIG. 29, wireless devices 100 and 200 may correspond to the wireless devices 100 and 200 of FIG. 26 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 26. For example, the transceiver(s) 114 may include the one or more transceivers 106 and 206 and/or the one or more antennas 108 and 208 of FIG. 26. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. In addition, the control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

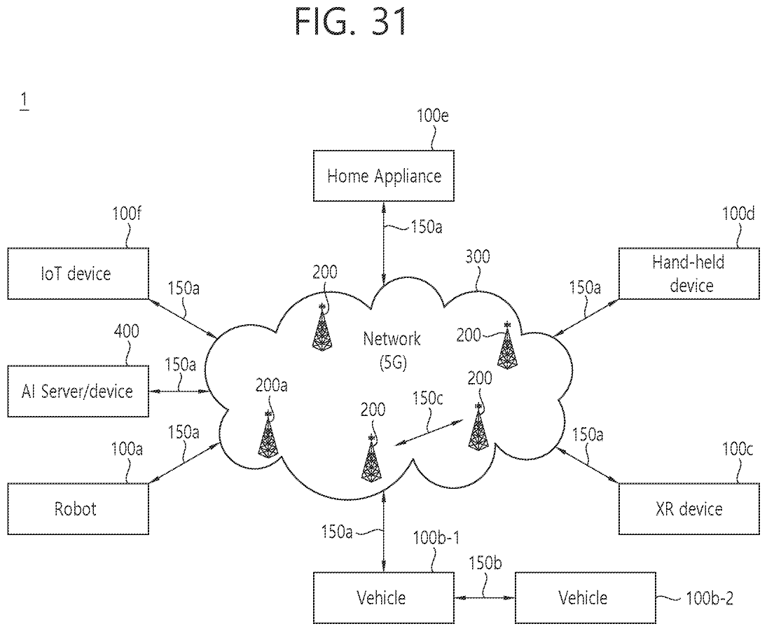

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 31), the vehicles (100b-1 and 100b-2 of FIG. 31), the XR device (100c of FIG. 31), the hand-held device (100d of FIG. 31), the home appliance (100e of FIG. 31), the IoT device (100f of FIG. 31), a digital broadcast terminal, a hologram device, a public safety device, an MTC device, a medicine device, a fintech device (or a finance device), a security device, a climate/environment device, the AI server/device (400 of FIG. 31), the BSs (200 of FIG. 31), a network node, etc. The wireless device may be used in a mobile or fixed place according to a use-example/service.

In FIG. 26, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. In addition, each element, component, unit/portion, and/or module within the wireless devices 100 and 200 may further include one or more elements. For example, the control unit 120 may be configured by a set of one or more processors. For example, the control unit 120 may be configured by a set of a communication control processor, an application processor, an Electronic Control Unit (ECU), a graphical processing unit, and a memory control processor. For another example, the memory 130 may be configured by a Random Access Memory (RAM), a Dynamic RAM (DRAM), a Read Only Memory (ROM)), a flash memory, a volatile memory, a non-volatile memory, and/or a combination thereof.

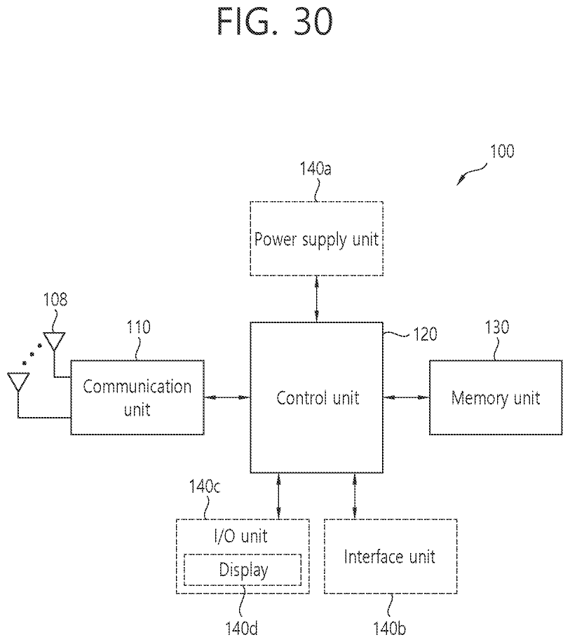

FIG. 30 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 30, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c respective correspond to the blocks 110 to 130/140 of FIG. 28.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. In addition, the memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

For example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. In addition, the communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Additionally, the methods described herein can be realized by a computer-readable communication medium that carries or communicates code, at least in part, in the form of instructions or data structures, and that a computer can access, read, and/or execute.

According to some implementations of this specification, a non-transitory computer-readable medium (CRM) stores a plurality of instructions.

More specifically, a CRM stores instructions that cause operations to be performed by one or more processors. The operations comprise based on the mobile node being set to a first mode: measuring a plurality of beams using synchronization signal/physical broadcast channel block (SSB) or channel state information-reference signal (CSI-RS) resources, reporting a measurement result of at least one best beam among the plurality of beams, based on the mobile node being set to a second mode: receiving a first beam table from a fixed node, wherein the first beam table comprising beam information for each of a plurality of beams to be operated by the fixed node, transmitting a second beam table to the fixed node, wherein the second beam table comprising beam information for each of a plurality of beams to be operated by the mobile node, transmitting to the fixed node information relating to a first beam index of the second beam table and a first time point, wherein the first beam index is a beam index to be operated by the mobile node at the first time point, transmitting to the fixed node, based on an occurrence of a movement event of the mobile node, information relating to a second beam index of the second beam table and a second time point, wherein the second beam index is a beam index to be operated by the mobile node at the second time point, and wherein the second beam index is selected from the second beam table, taking into account a predicted position of the mobile node due to the movement event and the first beam table.

FIG. 31 illustrates a communication system 1 applied to the present disclosure.

Referring to FIG. 31, a communication system 1 applied to the present specification includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). In addition, the IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g, relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Meanwhile, the NR supports multiple numerologies (or subcarrier spacing (SCS)) for supporting diverse 5G services. For example, if the SCS is 15 kHz, a wide area of the conventional cellular bands may be supported. If the SCS is 30 KHz/60 KHz, a dense-urban, lower latency, and wider carrier bandwidth is supported. If the SCS is 60 KHz or higher, a bandwidth greater than 24.25 GHz is used in order to overcome phase noise.

An NR frequency band may be defined as a frequency range of two types (FR1, FR2). Values of the frequency range may be changed. For example, the frequency range of the two types (FR1, FR2) may be as shown below in Table 5. For convenience of explanation, among the frequency ranges that are used in an NR system, FR1 may mean a “sub 6 GHz range”, and FR2 may mean an “above 6 GHz range” and may also be referred to as a millimeter wave (mmW).

TABLE 5

| Frequency Range | Corresponding frequency | Subcarrier Spacing |
|---|---|---|
| designation | range | (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed. For example, as shown in Table 6 below, FR1 may include a band in the range of 410 MHz to 7125 MHz. That is, FR1 may include a frequency band of at least 6 GHz (or 5850, 5900, 5925 MHz, and so on). For example, a frequency band of at least 6 GHz (or 5850, 5900, 5925 MHz, and so on) included in FR1 may include an unlicensed band. The unlicensed band may be used for diverse purposes, e.g., the unlicensed band for vehicle-specific communication (e.g., automated driving).

TABLE 6

| Frequency Range | Corresponding | Subcarrier Spacing |
|---|---|---|
| designation | frequency range | (SCS) |
| FR1 | 410 MHz-7125 MHz | 15, 30, 60 kHz |
| FR2 | 24250 MHz-52600 MHz | 60, 120, 240 kHz |

Claims disclosed in the present specification can be combined in various ways. For example, technical features in method claims of the present specification can be combined to be implemented or performed in an apparatus, and technical features in apparatus claims of the present specification can be combined to be implemented or performed in a method. Further, technical features in method claims and apparatus claims of the present specification can be combined to be implemented or performed in an apparatus. Further, technical features in method claims and apparatus claims of the present specification can be combined to be implemented or performed in a method.

1. A method, comprising:
based on a mobile node being set to a first mode: measuring, by the mobile node, a plurality of beams using synchronization signal/physical broadcast channel block (SSB) or channel state information-reference signal (CSI-RS) resources,
reporting, by the mobile node, a measurement result of at least one best beam among the plurality of beams, to a fixed node,
based on the mobile node being set to a second mode: receiving, by the mobile node, a first beam table from the fixed node, wherein the first beam table comprising beam information for each of a plurality of beams to be operated by the fixed node,
transmitting, by the mobile node, a second beam table to the fixed node, wherein the second beam table comprising beam information for each of a plurality of beams to be operated by the mobile node,
transmitting, by the mobile node, to the fixed node information relating to a first beam index of the second beam table and a first time point, wherein the first beam index is a beam index to be operated by the mobile node at the first time point,
transmitting, by the mobile node, to the fixed node, based on an occurrence of a movement event of the mobile node, information relating to a second beam index of the second beam table and a second time point,
wherein the second beam index is a beam index to be operated by the mobile node at the second time point, and
wherein the second beam index is selected from the second beam table, taking into account a predicted position of the mobile node due to the movement event and the first beam table.

2. The method of claim 1, wherein when transmitting the first beam index, first predicted power information to be used at the first time point is transmitted together.

3. The method of claim 2, wherein when transmitting the second beam index, second predicted power information to be used at the second time point is transmitted together.

4. The method of claim 3, wherein the first beam index, the first predicted power information, the second beam index, and the second predicted power information are used by the fixed node to estimate a beam index of the first beam table to be used by the fixed node at the second time point.

5. The method of claim 1, wherein when transmitting the first beam index, position information and inertial sensor information of the mobile node related to the first time point are transmitted together.

6. The method of claim 1, wherein when transmitting the second beam index, position information and inertial sensor information of the mobile node related to the second time point are transmitted together.

7. The method of claim 6, wherein the position information and the inertial sensor information are used by the fixed node to estimate the predicted position of the mobile node.

8. The method of claim 1, wherein the second beam table is specific to the mobile node.

9. The method of claim 1, further comprising:
transmitting a third beam table to the fixed node,
wherein the third beam table is a beam table that has updated the second beam table.

10. A mobile node, comprising:
at least one transceiver for transmitting and receiving a wireless signal;
at least one memory; and
at least one processor operably coupled with the at least one memory and the at least one transceiver,
wherein the at least one memory stores instructions that, based on being executed by the at least one processor, cause the at least one processor to perform operations comprising:
based on the mobile node being set to a first mode: measuring a plurality of beams using synchronization signal/physical broadcast channel block (SSB) or channel state information-reference signal (CSI-RS) resources,
reporting a measurement result of at least one best beam among the plurality of beams,
based on the mobile node being set to a second mode: receiving a first beam table from a fixed node, wherein the first beam table comprising beam information for each of a plurality of beams to be operated by the fixed node,
transmitting a second beam table to the fixed node, wherein the second beam table comprising beam information for each of a plurality of beams to be operated by the mobile node,
transmitting to the fixed node information relating to a first beam index of the second beam table and a first time point, wherein the first beam index is a beam index to be operated by the mobile node at the first time point,
transmitting to the fixed node, based on an occurrence of a movement event of the mobile node, information relating to a second beam index of the second beam table and a second time point,
wherein the second beam index is a beam index to be operated by the mobile node at the second time point, and
wherein the second beam index is selected from the second beam table, taking into account a predicted position of the mobile node due to the movement event and the first beam table.

11. The mobile node of claim 10, wherein when transmitting the first beam index, first predicted power information to be used at the first time point is transmitted together.

12. The mobile node of claim 11, wherein when transmitting the second beam index, second predicted power information to be used at the second time point is transmitted together.

13. The mobile node of claim 12, wherein the first beam index, the first predicted power information, the second beam index, and the second predicted power information are used by the fixed node to estimate a beam index of the first beam table to be used by the fixed node at the second time point.

14. The mobile node of claim 10, wherein when transmitting the first beam index, position information and inertial sensor information of the mobile node related to the first time point are transmitted together.

15. The mobile node of claim 10, wherein when transmitting the second beam index, position information and inertial sensor information of the mobile node related to the second time point are transmitted together.

16. The mobile node of claim 15, wherein the position information and the inertial sensor information are used by the fixed node to estimate the predicted position of the mobile node.

17. The mobile node of claim 10, wherein the second beam table is specific to the mobile node.

18. The mobile node of claim 10, the processor is further adapted to:
transmit a third beam table to the fixed node,
wherein the third beam table is a beam table that has updated the second beam table.

19. A method, comprising:
based on a mobile node being set to a first mode: setting, by a fixed node, synchronization signal/physical broadcast channel block (SSB) or channel state information-reference signal (CSI-RS) resources to the mobile node for each of a plurality of beams,
receiving, by the fixed node from the mobile node, a measurement result of at least one best beam among the plurality of beams,
based on the mobile node being set to a second mode: transmitting, by the fixed node, a first beam table to the mobile node, wherein the first beam table comprising beam information for each of a plurality of beams to be operated by the fixed node,
receiving, by the fixed node from the mobile node, a second beam table, wherein the second beam table comprising beam information for each of a plurality of beams to be operated by the mobile node,
receiving, by the fixed node from the mobile node, information relating to a first beam index of the second beam table and a first time point, wherein the first beam index is a beam index to be operated by the mobile node at the first time point,
receiving, by the fixed node from the mobile node, based on an occurrence of a movement event of the mobile node, information relating to a second beam index of the second beam table and a second time point,
wherein the second beam index is a beam index to be operated by the mobile node at the second time point, and
wherein based on the first beam index and the second beam index, the fixed node selects a beam index of the first beam table to be used by the fixed node at the second time point.

20-22. (canceled)
